(19) United States
(12) Patent Application Publication
(10) Pub. No.: US 2011/0131135 A1
(43) Pub. Date: Jun. 2, 2011

(54) ONLINE WARRANTY HISTORY STORAGE ACCESS

(76) Inventors: Mark Carlson, Half Moon Bay, CA (US); Pat Stan, Pacifica, CA (US); Patrick L. Faith, Pleasanton, CA (US); Ayman A. Hammad, Pleasanton, CA (US); Ben Rewis, Oakland, CA (US)

(21) Appl. No.: 12/861,115

(22) Filed: Aug. 23, 2010

Related U.S. Application Data
(60) Provisional application No. 61/236,777, filed on Aug. 25, 2009.

(51) Int. Cl. G06Q 10/00; G06Q 40/00

(52) U.S. Cl. 705/44; 705/302

(57) ABSTRACT

A message confirming a transaction for the purchase of an item can include identifiers for the item and for a consumer as well as information pertaining to the transaction. The item identifier is used to locate an express warranty for the item. The consumer identifier (e.g.; a number of an account issued to the consumer) is used to locate the consumer's file in which the express warranty is stored along with at least a portion of the information pertaining to the transaction. Other data received in respective messages can be also be stored in the consumer's file. Thereafter, the consumer identifier can be use to retrieve all express warranties stored in the file for past respective purchased items. Information about each express warranty can be compared to the stored portion of the information pertaining to the transaction so as to retrieve only those express warranties that are valid (e.g.; unexpired).

### CROSS-REFERENCE TO RELATED APPLICATIONS

This application claims priority to, and the benefit of, U.S. Provisional Application Ser. No. 61/236,777, filed on Aug. 25, 2009, titled “Warranty and Benefits Incentive Network,” which is incorporated herein by reference.

### FIELD

The present invention is related to an item purchased by a consumer from a merchant, and is more particularly related to an express warranty for the item. The express warranty, which is made in association with the purchase of the item by the consumer, can be from the merchant from whom the consumer purchased the item, a manufacturer of the item, a wholesaler of the item, or other third party. The express warranty is a textually expressed promise, optionally with expressed remedies for breach(es) thereof, concerning the character, nature, performance, purpose, quality, state, or use of the item.

### BACKGROUND

A factor upon which a consumer may use as a basis for making a purchase of an item can be an express warranty that covers the item as against defects and damage for a cost of repair and/or replacement (e.g.; provides a remedy for breach). A consumer who purchases the item, however, may misplace or lose documentation for the express warranty, or otherwise forget terms and conditions of the express warranty such as an expiration date for the express warranty, or may forget that there will be a time or place at which the express warranty is not, or is no longer, valid. It would be an advantage in the art to solve one or more of the forgoing problems.

### SUMMARY

In one implementation, one or more authorization messages are received, each being for a transaction on an account between a merchant and a consumer (e.g.; a credit or debit card account, or other account type). Each authorization message can be an authorization request message, an authorization response message, or combination thereof. Each authorization message can include an account identifier corresponding to the account issued by an issuer to the consumer, one or more Globally Unique Item Identifiers (GUIIDs) each corresponding to an item purchased in the transaction, and information pertaining to the transaction including confirmation that the transaction on the account had been authorized by the issuer of the account.

The authorization message can be a financial transaction card originated message having one or more private use fields and for which interchange message specifications are predetermined for the exchange of electronic transactions made by cardholders using payment cards (e.g.; the International Standards Organization (ISO) 8583 standard). Each of the GUWIDs can be stored in the one or more private use fields of the authorization message.

Using the account identifier, an identification is made of a consumer file from a plurality thereof that are stored in a consumer database. For each GUIID, an identification is made, using the GUIID, of the item and a corresponding Globally Unique Warranty Identifier (GUWID) in a warranty database. The warranty database includes a plurality of the GUWIDs each having a corresponding express warranty for a corresponding item. A storing step takes place so as to be associated with the identified consumer file in the consumer database, where the GUWID for the corresponding said item is stored along with at least a portion of the information pertaining to the transaction is stored.

In the foregoing implementation, a consumer warranty request can be received that includes the account identifier. Using the account identifier, the consumer file is retrieved from the consumer database. Each GUWID is retrieved that was stored in the consumer file that was retrieved from the consumer database. A retrieval is made, from the warranty database, of each express warranty that corresponds to each GUWID that is stored within the retrieved consumer file from the consumer database. In response to the consumer warranty request, the express warranties that were retrieved from the warranty database are transmitted. The express warranties that are transmitted can be limited to those express warranties that are still valid, where the validity can be determined by a comparison of stored information pertaining to the transaction with warranty terms of the express warranty.

In alternatives to the foregoing implementations, a consumer can use a client to communicate over a network (e.g.; the Internet) with a server, or system thereof, to store warranty information in a consumer-specific file maintained by the server for each item purchased by the consumer that has an express warranty. The server can retrieve express warranty information for the item, as above, by using a globally unique identifier for the item that is provided by the consumer via the client.

### BRIEF DESCRIPTION OF THE DRAWINGS

Implementations of the invention will become more apparent from the detailed description set forth below when taken in conjunction with the drawings, in which like elements bear like reference numerals.

FIG. 1 illustrates an exemplary payment processing network, depicting the general environment wherein an express warranty may be stored in a consumer warranty file for an item purchased using a portable consumer payment device;

FIGS. 2 illustrates the general environment wherein a portable consumer payment device is used by a consumer to purchase an item from a merchant, wherein the item is associated with an express warranty;

FIGS. 3-5 depicts flow charts of respective exemplary methods for associating, by way of a consumer's account, warranty information for items purchased by the consumer.

### DETAILED DESCRIPTION

In the present context, a consumer warranty database is maintained by a transaction handler or agent thereof. The consumer warranty database includes warranty information for items purchased by consumers using respective portable consumer payment devices each of which is associated with an account issued to a respective consumer. The database can then be accessed by a consumer, using their account, in order to obtain warranty information for a purchased item. While the present discussion focuses on warranties, one of ordinary skill in the art will appreciate that the method and system described is equally applicable to insurance and other benefits, and that the use of the method and system with insurance policies and other benefits is within the scope of the invention described.

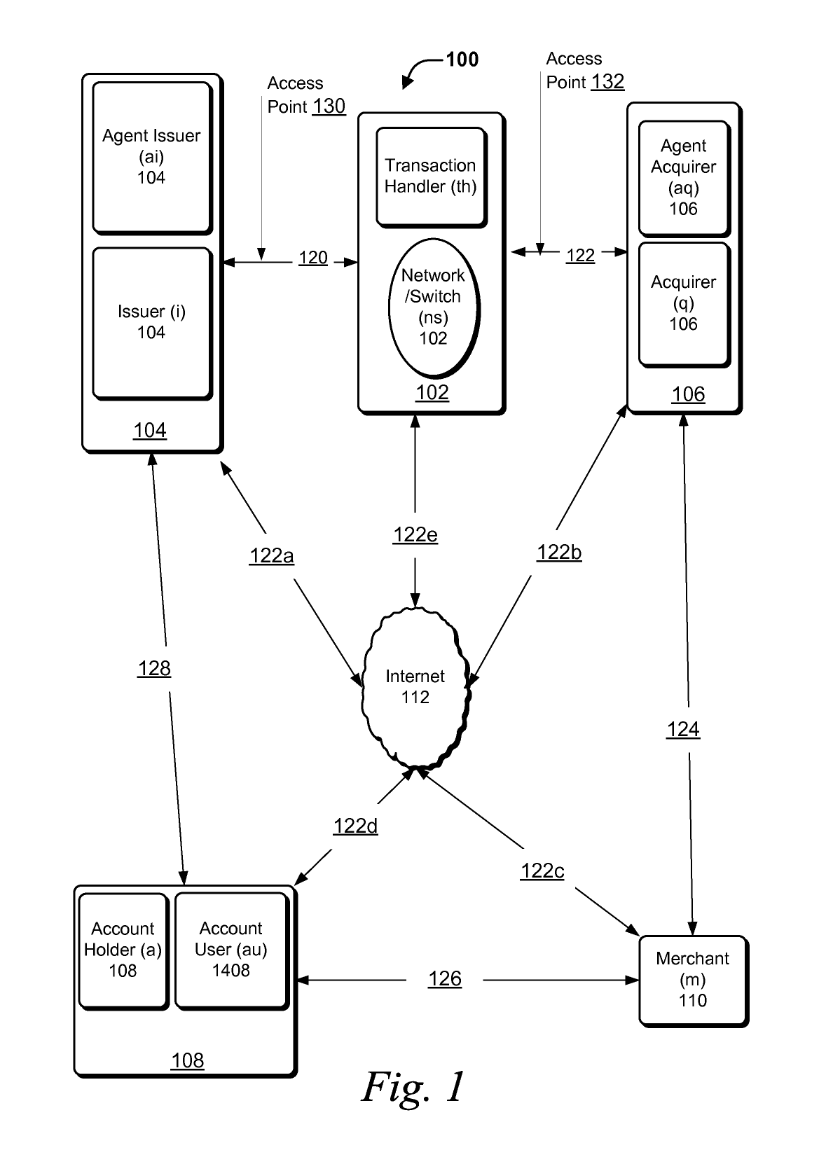

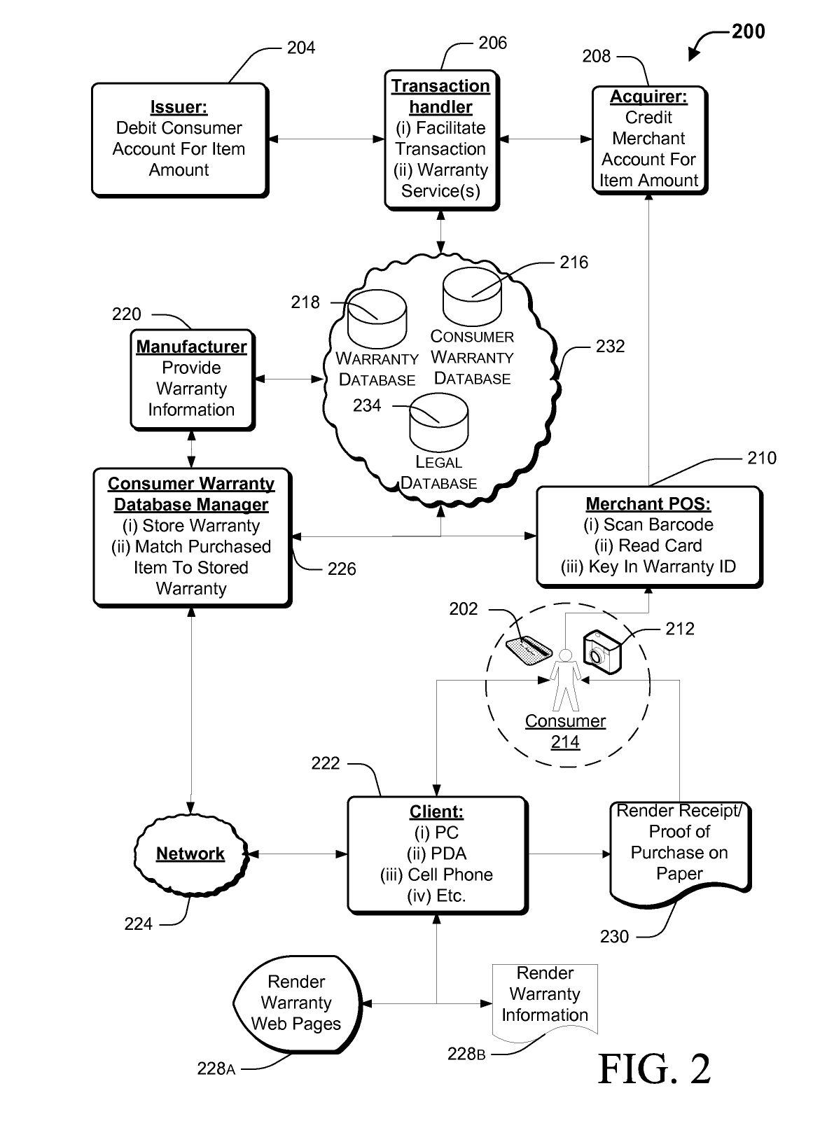

Within the exemplary payment processing system depicted in FIG. 1, discussed in detail below, FIG. 2 illustrates the general environment wherein a portable consumer payment device, such as portable consumer payment device 202, is used by consumer 214 to purchase item 212 from merchant 210, wherein item 212 is associated with a warranty, and where portable consumer payment device is associated with an account issued by an issuer to consumer 214. While item 212 is depicted as a digital camera, a person of ordinary skill in the art will appreciate that item 212 may be any item sold with a warranty. By way of example and not limitation, item 212 may be an electronic item, such as a computer, electro-mechanical household appliance, or audio stereo system, a household item, such as a refrigerator, a window, or an air conditioner, or a recreational item, such as a bicycle, snowboard, or jet ski. Furthermore, while portable consumer payment device 202 is depicted as a substantially planar laminated card, one skilled in the relevant arts will recognize that other forms of transaction tokens could be used in the disclosed implementations.

In certain implementations, the item purchased is insurance. In such implementations, the insurance may be shipping insurance, cruise insurance, car rental insurance, or a similar short term insurance policy. In other implementations, the item purchased is a benefit. In such implementations, the benefit may be, for example. an extended warranty policy that is over and above a standard warranty on a purchased item.

Turning to FIG. 2, in certain implementations, consumer 214 presents item 212 to merchant 210's point of sale terminal (POS) for purchase along with portable consumer payment device 202. In other implementations, consumer 214 may be purchasing item 212 via the Internet, by telephone, by fax, or by any other method available for purchasing goods and services.

Retail merchant 210 uses a card reader associated with the POS terminal to read the information stored on portable consumer payment device 202, including the account identifier associated with an account issued by issuer 204. In certain implementations, portable consumer payment device 202 is read by swiping portable consumer payment device 202 through the POS terminal to read data magnetically encoded in a magnetic stripe. In other implementations, the POS terminal reads portable consumer payment device 202 using a contactless technology, such as Near Field Communications (NFC), Radio Frequency Identification (RFID) communications, etc., when consumer 214 is near the POS terminal. In yet other implementations, to be read, portable consumer payment device 202 is inserted into the POS terminal such that external contacts on portable consumer payment device 202 establish connectivity with the POS terminal.

Upon receipt of portable consumer payment device 202, the transaction is processed similarly to a method described below in connection with FIG. 1. Merchant 210 submits an authorization request message to acquirer 106, which includes the account identifier for an account issued by issuer 204 and read from portable consumer payment device 202. Merchant 210 also submits a warranty identifier for a warranty offered on item 212. In certain implementations, the warranty identifier must be manually entered into merchant 210's POS. In other implementations, the warranty identifier is determined by merchant 210's POS based on item 212. In certain implementations, an identifier of item 212 is the warranty identifier.

In certain implementations, more than one warranty identifier can be included in one or more private use fields of the authorization request message. In such implementations, one warranty identifier may be for manufacturer's warranty on item 212 while a second warranty identifier may pertain to an extended warranty purchased by consumer 214 separately. In such implementations, consumer 214 may have purchased multiple items each having a respective warranty, wherein each warranty identifier that is included in the authorization request message is associated with a respective item that was purchased by consumer 214.

In implementations where item 212 is an insurance policy or other benefit, the identifier may actually be, for example, an identifier for the insurance policy or an extended warranty. Where acquirer 208 is not the same entity as the issuer of the account associated with the account identifier read from portable consumer payment device 202, acquirer 208 forwards the transaction information to a transaction handler 206, who in turn forwards it to issuer 204 to verify that the account associated with consumer 214 contains sufficient funds and/or credit for same to reimburse merchant 210 for the purchase price of item 212.

Upon receipt of an authorization response message as a reply from issuer 204, transaction handler 206 forwards the authorization response message to acquirer 208, who forwards it to merchant 210. Where the authorization response message contains an approval of the transaction, transaction handler 206 additionally matches the warranty identifier with a warranty stored in database 218.

In certain implementations, the warranties stored in database 218 are provided by merchant 210. In other implementations, information pertaining to warranties stored in database 218 is provided by manufacturer 220 of item 212. In other implementations, the warranties stored in database 218 are provided by any other entity having an interest in providing a warranty that covers a purchased of item 212, for instance by a Consumer Warranty Database Manager 226.

In certain implementations, insurance policies and extended warranties are also stored in database 218. In such implementations, each such insurance policy and extended warranty may be supplied by the provider of the policy or warranty. Furthermore, in such implementations, the warranty identifier included in the authorization request message can be an identifier for an insurance policy or and extended warranty stored in database 218. The transaction handler or its agent, in such implementations, matches the identifier with an insurance policy or extended warranty stored in database 218. In other implementations, the Consumer Warranty Database Manager 226 or its agent, matches the identifier with an insurance policy or extended warranty stored in database 218.

Once the warranty identifier is matched with a warranty stored in database 218, the warranty is stored in a consumer warranty database 216, wherein the consumer warranty for a purchased item is identified by the account identifier associated with portable consumer payment device 202.

In certain implementations, if a warranty identifier included in an authorization request message to store the warranty for the item 212 does not match a warranty stored in the warranty database 218, the consumer warranty database manager 226 sends a diagnostic to the merchant 210, or the provider of the warranty (i.e.; the manufacturer 220), or agent(s) thereof, with a notification that no warranty information for the item 212 is stored in the warranty database 218 and requesting that the information be submitted, if needed. In certain implementations, if transaction handler 206 is unable to match the warranty identifier to a warranty stored in database 218, transaction handler 206 includes in the authorization response message information that indicates that the warranty identifier is invalid. In such an implementation, merchant 210 may then provide the warranty information to transaction handler 206 via communications through a network 232. In other implementations, when transaction handler 206 is unable to match the warranty identifier to a warranty stored in database 216, transaction handler 206 provides a notification to the manufacturer 220 (or to a distributor or wholesaler of item 212) or other third party offering a warranty on item 212 sp as to notify the third party that the warranty is not stored in database 218. In such implementations, the authorization request message may include an identifier of the provider of the warranty for item 212.

In certain implementations, matching the warranty identifier (e.g.; a Globally Unique Warranty Identifier (GUWID)) with a warranty stored in warranty database 218 may involve additional processing. In such implementations, the authorization request message may include additional information, by way of example and not limitation, an identifier for item 212 (e.g.; a Globally Unique Item Identifier (GUIID), such as the stock keeping unit (SKU), a serial number, a universal product code (UPC), or other Globally Unique Identifier (GUID), the provider of the warranty, the merchant, and/or a method of purchase. In one implementation, transaction handler 206 may, for example, only store warranty information for a product in a consumer warranty file when the product is purchased online at a specific store, using a credit card associated with an account issued by a specific issuer. In such an implementation, the warranty information may include such requirements. Once transaction handler 206 has identified the warranty for item 212 stored in database 218, transaction handler 206 may then use the additional information to ensure that the requirements have been met before storing the warranty information in a consumer's file kept in the consumer warranty database 216.

Once the authorization request message is approved, merchant 210 may submit a payment request to payment processing system 100 for reimbursement for the cost of item 212 from the account associated with portable consumer payment device 202. Typically, a clearing and settlement process involves merchant 210 submitting a request for payment to acquirer 208. Where acquirer 208 is not the same entity as the issuer of the account associated with the account identifier stored on portable consumer payment device 202, acquirer 208 forwards the request to transaction handler 206. Transaction handler 206 in turn requests payment for the cost of item 212 from issuer 204, where issuer 204 is the issuer of the account associated with portable consumer payment device 202. Issuer 204 debits the account and forwards the payment to transaction handler 206 who forwards the payment to acquirer 208. Finally, acquirer 208 credits the account of merchant 210 for the cost of item 212.

After the warranty information for item 212 has been stored in consumer warranty database 216 for consumer 214, consumer 214 can access that warranty information at a later time. In certain implementations, consumer 214 uses a client 222 to connect, through a network 224, to the consumer warranty database manager 226. The services provided by the consumer warranty database manager 226 allow consumer 214 to see warranties for items purchased by consumer 214 on an account associated with the consumer's portable consumer payment device 202. The warranted purchases on the account are thus available for viewing and/or download. In respective implementations, computer system 222 is web-enabled and can be a desktop personal computer, a laptop computer, a Personal Digital Assistant (PDA), a tablet computer, a cellular telephone, a kiosk, a hand held computing device that is enabled for Internet and/or World Wide Web communication via cellular telephony or other wireless communications capabilities, etc.

In yet another implementation, after warranty information about a product has been received from a manufacturer or other supplier and stored in warranty database 218 by an entity such as the transaction handler 206 or the consumer warranty database manager 226, a merchant 210 completes a transaction on an account with the consumer 214 for the purchase of an item 212. Thereafter, in real time or in a batch mode, the merchant 210 sends information about the transaction to the consumer warranty database manager 226. The consumer warranty database manager 226 can be an agent of the merchant 210, the merchant's acquirer 208, the transaction handler 206, or another party. The consumer warranty database manager 226 stores the consumer 212's account with the item 212 purchased on the account, after matching, within consumer warranty database 216, the purchased item 212 with a previously stored warranty in warranty database 218 that had previously been received from the manufacture 220 or other warrantor. In certain implementations, the consumer warranty database manager 226 will also verify that the conditions for storing the warranty information in the consumer's file within the consumer warranty database 216 have also been met.

In a still further implementation, warranty information about an item 212 is received and stored in a warranty database 218 in association with an identifier for the item 212. Consumer 214 who wishes to keep track of the warranties for items they have purchased, sends an identifier for an account corresponding to portable payment device 202, where the account has been issued to the consumer 212 by an issuer 204. Also sent by the consumer 214 is an identifier for each item 212 purchased by the consumer 214 for which there is a warranty, whether or not purchased on the consumer's account 202. A consumer warranty database manager 226 attempts to match or associate each item 212 identifier received from the consumer 214 with a warranty in warranty database 216. For each match, identifiers for the account 202, the item 212, and the corresponding warranty are stored in consumer warranty database 216. Thereafter, the consumer 214 may retrieve warranty information about a prior purchased item 212 by use of client 222 to access, via network 224, consumer warranty database manager 226 and/or consumer warranty database 216 and warranty database 218.

In the illustrated implementation of FIG. 2, computer system 222 renders communications that have been received from Consumer Warranty Database Service 226 on a display (e.g.; 228a, 228b) that is in communication with client 222. For instance, the display device can display the warranties for items purchased on the consumer 214's account. Consumer Warranty Database Service 226 is in communication with Consumer Warranty Database 216 for matching consumer 214's account to items purchased on the account and is functional to conduct searches in consumer warranty database 216 having respective consumer warranty files, account to the consumer's account(s), for items purchased by the consumer 214. More than one account of consumer 214 can be searched so as to locate all purchases of items have are covered by a warranty by way of association with one or more of the consumer 214's accounts.

Consumer 214, via client 222, network 224 and Consumer Warranty Database Manager 226, selects the warranty for item 212 from among the warranties for the various items consumer 214 has purchased using portable consumer payment device 202. Upon such selection, information related to the warranty for item 212 is retrieved and downloaded to client 222 for rendering on the associated display (e.g., 228a, 228b). In certain implementations, the information is retrieved from a database, such as the consumer warranty database 216, and may include, by way of example and not limitation, the expiration date of the warranty, directions on how to make a claim under the warranty, recommended methods for shipping item 212 to an address, local representatives who can repair or service item 212, local merchants to whom item 212 can be returned for an exchange of the item for the same or a similar item, or any other information related to the warranty. In certain implementations, an advertisement is also displayed. In such implementations, the advertisement may be related to item 212, such as, by way of example and not limitation, an advertisement for a product that can be used with item 212 or an advertisement for a purchase of an extended warranty.

In certain implementations, a receipt and/or proof of purchase for item 212 is available for download from consumer warranty database 216. In such an implementation, consumer 214 may make a print-out 230 of the receipt and/or proof of purchase. In certain implementations, print-out 230 additionally includes advertisements. In certain implementations, print-out 230 additionally includes important information about the warranty for item 212, such as terms and conditions provided by the warranty.

Consumer 214 uses the information provided by the consumer warranty database manager 226 and, in certain implementations print-out 230, to make a claim under the warranty for item 212.

In alternatives to the forgoing implementations, information that can be used to store warranty data pertaining to an item purchased from a merchant by a consumer in a transaction on an account can be derived from one or more authorization messages. The account identified in each such authorization message can be a credit or debit card account, or other account type. Each authorization message can be an authorization request message, an authorization response message, or combination thereof, that is sent and/or received by an issuer of the account, the merchant's acquirer, and/or a transaction handler that is in communication with both issuer and the merchant's acquirer. Each authorization message can include an account identifier corresponding to the account issued by the issuer to the consumer as well as one or more Globally Unique Item Identifiers (GUIIDs) each identifying an item purchased from the merchant in the transaction with the consumer. The authorization message can be a financial transaction card originated message having one or more private use fields for storage of each of the Globally Unique Warranty Identifiers (GUWIDs) and the GUIIDs. The authorization message can have corresponding interchange message specifications that are predetermined for the exchange of electronic transactions made by cardholders using payment cards (e.g.; the International Standards Organization (ISO) 8583 standard).

In certain implementations, the warranty information contained in a consumer's warranty file may be ‘data mined’ in order to provide additional functionality for use to provide notices, offers, or advertisements via mail, email, or other communication method. By way of example and not limitation, the warranty information stored in the consumer's warranty file may be used to determine when the warranty expires so as to send to the consumer a reminder about the warranty expiration date and/or to send an offer to purchase an extended warranty. Furthermore, the warranty information may be used to identify a product or service that the consumer is likely to purchase and to provide a discount coupon for the product or service to the consumer. In such an implementation, the discount coupon may be for a routine service required under the warranty and may be sponsored by a local service provider.

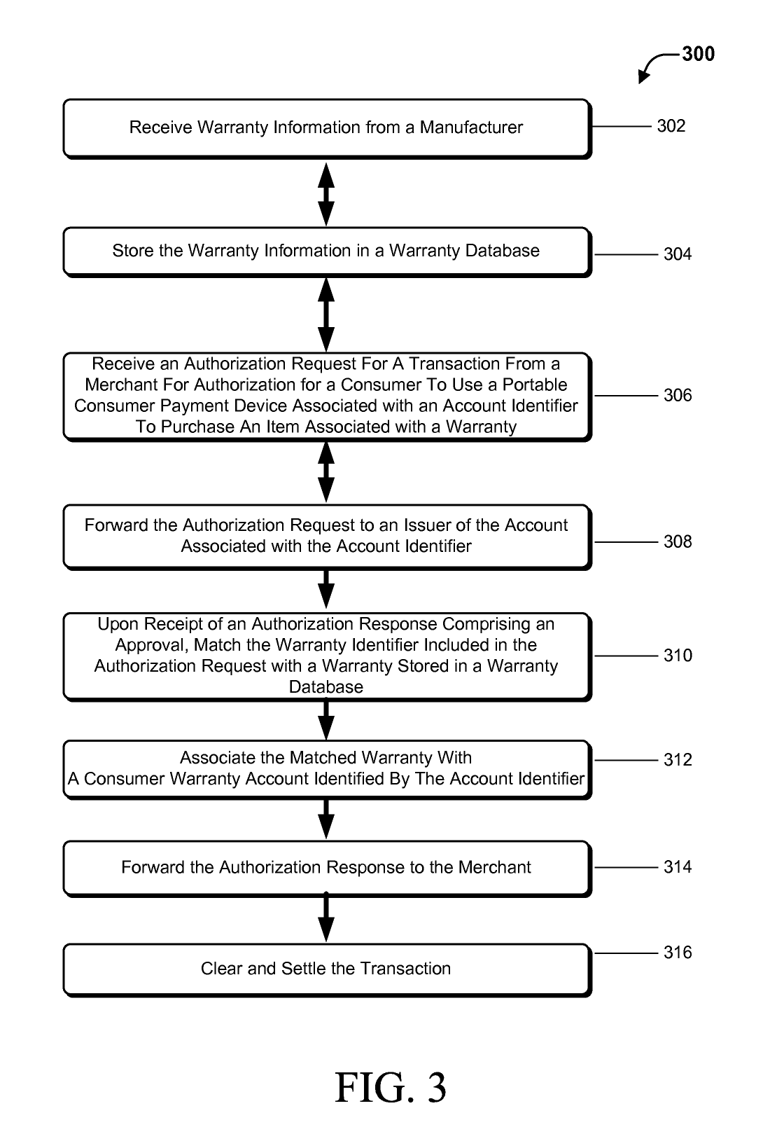

Within the exemplary payment processing system depicted in FIG. 1, discussed in detail below, FIG. 3 depicts a flow chart of an exemplary method 300 used by a transaction handler or agent(s) thereof to associate warranty information with a consumer warranty file. As indicated by blocks 302 and 304, the transaction handler receives warranty information about a product from a manufacturer or other supplier of the warranty and stores that information in a warranty database. In certain implementations, the transaction handler receives and stores additional information such as, by way of example and not limitation, requirements that must be met by a consumer at the time of purchase of an item for the warranty information to be stored in the consumer's warranty file. As indicated by block 306, the transaction handler then receives an authorization request message from a merchant, requesting authorization for a consumer to purchase the item using a portable consumer payment device and a warranty identifier for the item. Upon receipt of the request, the transaction handler sends a request to the issuer of the account associated with the portable consumer payment device to verify that the account contains sufficient funds to reimburse the merchant for the cost of the item, as indicated by block 308.

Upon receipt from the issuer of an authorization response message comprising an approval, the transaction handler matches the warranty identifier included in the request with the warranty information stored in the warranty database, as indicated by block 310. In certain implementations, the transaction handler will also verify that the conditions for storing the warranty information in the consumer's warranty file have also been met.

In certain implementations, if the warranty identifier included in an authorization request message does not match a warranty stored in the warranty database, the consumer warranty database manager sends a request to the merchant, or the provider of the warranty, or agent(s) thereof, with a notification that no warranty information for the item is stored in the warranty database and including a request that the warranty information be submitted.

In the illustrated implementation of FIG. 3, the transaction handler next sends a response to the retail merchant, as indicated by block 314. Finally, as indicated by block 316, the transaction handler clears and settles the transaction by requesting that the issuer debit the account of the consumer for the purchase amount and an acquirer for the merchant credit the merchant's account for the cost of the item purchased.

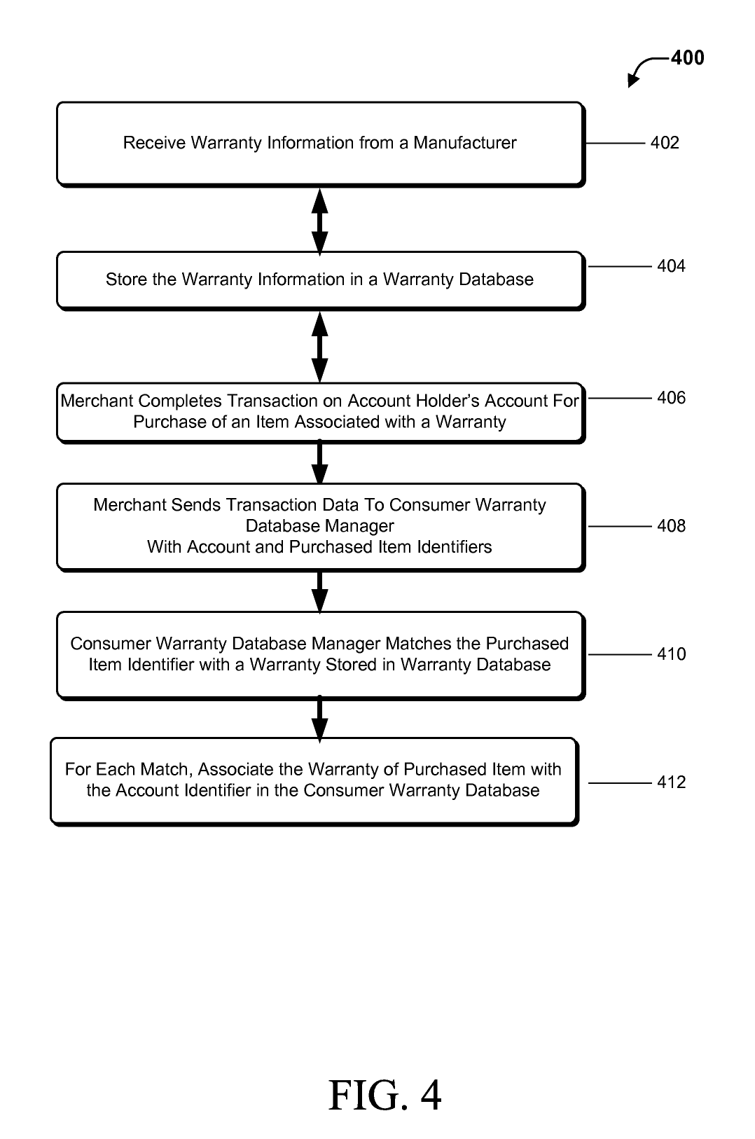

Within the exemplary payment processing system depicted in FIG. 1, discussed in detail below, FIG. 4, depicts a flow chart of an exemplary method 400 used by a merchant to associate warranty information with a consumer warranty file. As indicated by blocks 402 and 404, warranty information about a product from a manufacturer or other supplier of the warranty is received and stored in a warranty database. In certain implementations, the transaction handler, or agent(s) thereof, receives and stores additional information such as, by way of example and not limitation, requirements that must be met by an account holder at the time of purchase of an item for the warranty information pertaining to the item to be stored in the account holder's warranty file. As indicated by block 406, a merchant completes a transaction on an account with the account holder. Thereafter, in real time or in a batch mode, the merchant sends information about the transaction to a consumer warranty database manager. The consumer warranty database manager can be an agent of the merchant, the merchant's acquirer, the transaction handler, or another party. The consumer warranty database manager stores the account holder's account with the item purchased on the account, after matching the purchased item with a previously stored warranty received from the manufacture or other warrantor, as indicated by blocks 408-412. In certain implementations, the consumer warranty database manager will also verify that the conditions for storing the warranty information in the account holder's warranty file have been met.

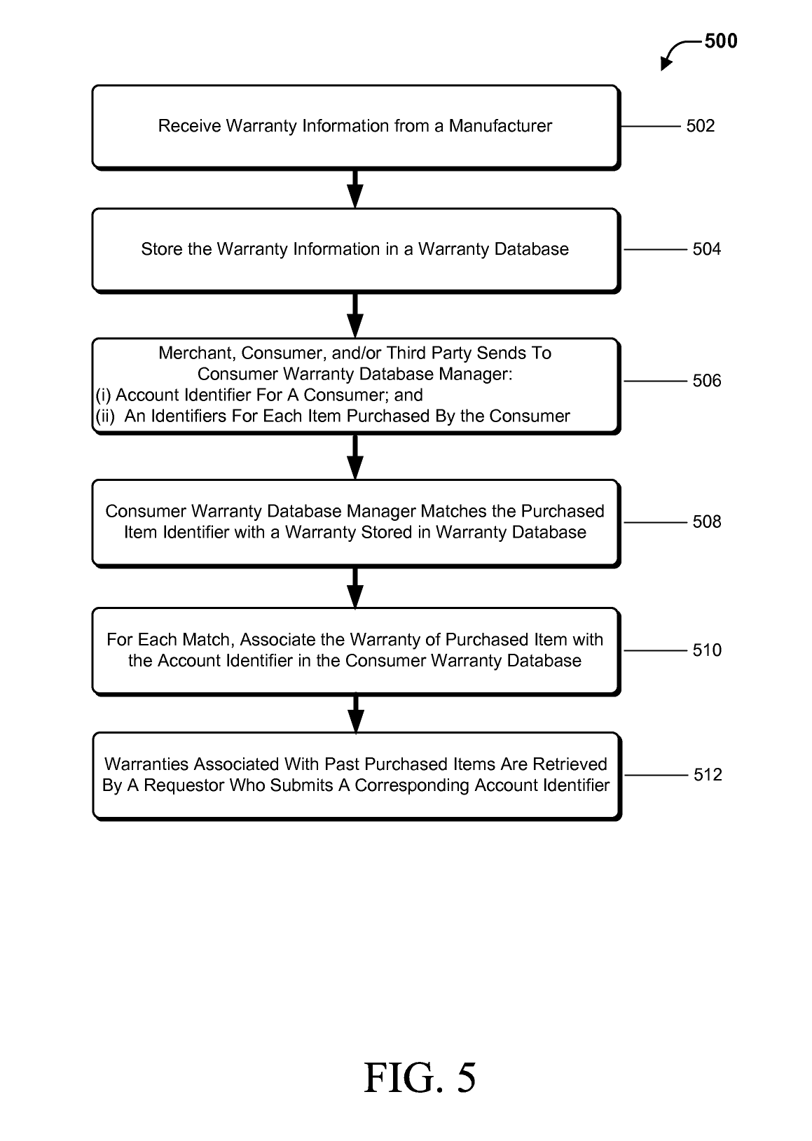

Within the exemplary payment processing system depicted in FIG. 1, discussed in detail below, FIG. 5 depicts a method 500 for how purchases of items under warranty can be associated with an account issued to a consumer with the warranties of those purchased items. Method 500 does not require a purchase of an item to have been made on the consumer's account. Rather, past purchases of items under warranty, whether or not purchased on the consumer's account, can be put into a consumer warranty database so as to associate the item purchased with both its warranty and the consumer's account. As indicated by blocks 502-504, any party can receive warranty information about a product from a manufacturer or other supplier of the warranty, and store that information in a warranty database. Data storage business rules can be established in order for method 500 to be performed so as to associate a consumer's purchased item with its warranty and with the consumer' account. As indicated by block 506, any party can send identifiers that are to be associated within a consumer warranty database, namely: (i) an identifier for the consumer's account; and (ii) an identifier for the purchased item by the consumer under a warranty whether not or the purchase was made in a transaction upon the consumer's account. A manager for the consumer warranty database, which can be an agent of the merchant, the merchant's acquirer, the transaction handler, and/or another party, will try to match or otherwise associate the identifier for the purchased item with a previously stored warranty in a warranty database. For each match or association, the consumer's account will be associated in the consumer warranty database with the purchased item and its warranty, as indicated by blocks 506-510. In certain implementations, the consumer warranty database manager will also verify that the conditions for storing this information in the consumer's warranty file have also been met. As shown in block 512, warranties associated with past purchased items can be are retrieved by a requestor (e.g.; a consumer accessing a website via the Internet) who submits a corresponding account identifier. For instance, such access can use an account number of an account issued by an issuer to the consumer, where the account was used by the consumer to purchase items having corresponding transaction data and respective warranties that are stored in the Consumer Warranty Database.

In one implementation of block 512, each retrieved warranty can include, in addition to the express warranty for the corresponding item that had been previously purchased, a statement of one or more implied warranties. To obtain the implied warranties, previously stored information is retrieved as pertains to the transaction in which the corresponding item that had been previously purchased, such as the date, location, jurisdiction of the purchase, and the merchant and category thereof from whom the item was purchased. This information is used to access one or more legal databases 234 in communication over network 232 as seen in FIG. 2. Such access to the one or more legal databases 234 is used to retrieve the one or more implied warranties representing the state of the law of commerce for the purchase of goods and/or services on the date, at the location, within the jurisdiction of the transaction, and as pertains to the merchant and category thereof of the transaction.

In addition to the express and implied warranties, other information pertaining to the transaction for the purchase of the item can also be retrieved via data mining operations on databases in communication via network 232, such as product recall notices of the item, offers for extended warranties for the item, class action suits pertaining to a class of purchasers of the item, offers for the purchase of related goods and services to the item, offers for the purchase of goods and services that may be of interest to the purchaser based upon other items purchased in the past by the purchasers for which warranty information has been stored in consumer warranty database 216. The retrieved information, including the express and implied warranties, will assist a purchaser to understand rights, privileges and responsibilities as pertains to a corresponding item that had been previously purchased in a transaction with a corresponding merchant.

In certain implementations, individual blocks of FIG. 3-5 described above may be combined, eliminated, or reordered. In certain implementations, instructions are encoded in a non-transient computer readable medium wherein those instructions are executed by hardware (e.g.; by one or more processors) to perform functions associated with one or more of the blocks seen in FIGS. 2-5. In yet other implementations, instructions reside in any other computer program product, where those non-transient instructions are executed by hardware (e.g. ‘one or more computerized apparatus) external to, or internal to, a system of hardware to perform functions associated with one or more of the blocks seen in FIGS. 2-5. In either case the instructions may be encoded in a computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, CompactFlash, SmartMedia, and the like. The steps of a method, process, or algorithm described in connection with the implementations disclosed herein may be embodied directly in hardware, in a software module executed by a processor, or in a combination of the two. In certain implementations, instructions are encoded in non-transient computer readable medium wherein those instructions are executed by hardware to perform one or more of the functions associated with the blocks seen, as described with respect to, FIG. 2-5.

The following example is presented to further illustrate to persons skilled in the relevant arts how to make and use the invention. This example is not intended as a limitation, however, upon the scope of the invention, which is defined only by the appended claims.

### EXAMPLE

By way of example and not limitation, a manufacturer may decide to offer a warranty on an electro-mechanical household appliance it produces and to participate in a warranty file program offered by a transaction handler. The manufacturer provides to the transaction handler the information on the warranty for the electro-mechanical household appliance to the transaction handler for storage in a warranty database, including the requirement that the electro-mechanical household appliance be purchased at an authorized retailer. A merchant, who is also an authorized retailer of the merchant's electro-mechanical household appliance, decides to offer an extended one-year warranty for all electronic items purchased in its store using the merchant's co-branded store credit card. The merchant provides the information regarding the extended warranty to the manufacturer, along with the items for which the extended warranty it is valid and the requirement that each such item be purchased using a co-branded store credit card.

A consumer may then present one of the manufacturer's electro-mechanical household appliances at the POS of the merchant for purchase using the merchant's co-branded store credit card. Using a scanner of the POS, the merchant scans a bar code on the electro-mechanical household appliance's packaging and reads, using a magnetic stripe reader, the consumer's account information stored in a magnetic stripe on the back of the consumer's co-branded store credit card.

The POS then forms an authorization request message, which includes the consumer's account identifier, the merchant's warranty identifier, and the identifier for the extended one-year warranty offered by the merchant. In certain implementations, the manufacturer's warranty identifier may be the same as a product identifier used by the merchant for stock keeping (e.g.; a Stock Keeping Unit or SKU). In certain implementations, the manufacturer's warranty identifier is a code provided by or to the merchant's POS. In other implementations, the manufacturer's warranty identifier is a code entered into the POS by the merchant.

The authorization request message is then sent to the merchant's acquirer, who forwards it to the transaction handler, who forwards it to the issuer of the account associated with the consumer's co-branded store credit card. The issuer then returns an authorization response message to the transaction handler. Where the authorization request message includes an approval of the transaction, the transaction handler matches the manufacturer's warranty identifier and the merchant's warranty identifier with the warranties stored in the warranty database.

The transaction handler additionally verifies that any requirements for storing the warranties in a consumer's warranty file have been met. In the present example, the transaction handler verifies, for the manufacturer's warranty, that the item is being purchased at an authorized retailer. Additionally, for the merchant's warranty, the transaction handler verifies that the transaction is being made using a merchant's co-branded store credit card. In certain implementations, this may be determined by examining the account identifier included in the authorization request message.

The transaction handler then stores the matched warranties in the consumer's warranty file along with the warranties for items the consumer has previously purchased. The consumer's warranty file is identified by the account identifier of the account associated with the consumer's co-branded store credit card.

Finally, the authorization response message is forwarded by the transaction handler to the acquirer, who forwards it to the merchant.

At a subsequent time, when the consumer is experiencing problems with the electro-mechanical household appliance, the consumer uses a web browser on a personal computer to browse to a website of the transaction handler's (of agent(s) thereof) and logs into an account having access to the consumer's warranty file. Once logged into the account, the personal computer renders a display having a listing for all of the warranties for items the consumer has purchased which are stored in the consumer's warranty file. The consumer scrolls to the manufacturer's warranty for the electro-mechanical household appliance and selects it, causing the display to show information relating to that warranty, such as whether the warranty is still valid, how to make a claim under the warranty, and where the closest authorized service provider is located. Additionally, a link may be provided which, when engaged, causes a printer attached to the personal computer to print out a copy of a proof of purchase for the electro-mechanical household appliance. Advertisements and notifications may also be displayed, such as, by way of example and not limitation, that the manufacturer's warranty will expire soon and that an extended warranty is available for purchase.**

Payment Processing System

Turning now to FIG. 1, an exemplary payment processing system 100 is illustrated depicting a general environment in which the payment processing system 200 can be realized, and the methods 300-500 can be performed. In payment processing system 100, a merchant (m) 110 can conduct a transaction for goods and/or services with an account user (au) on an account (i.e., a prepaid account) issued to an account holder (a) 108 by an issuer (i) 104, where the processes of paying and being paid for the transaction are coordinated by a transaction handler (th) 102, where the transaction handlers 102 include transaction handler (l) through transaction handler (TH), and where TH can be up to and greater than an eight digit integer. The transaction includes participation from different entities that are each a component of the payment processing system 100.

Payment processing system 100 has a plurality of merchants 110 that includes merchant (1) 110 through merchant (M) 110, where M can be up to and greater than an eight digit integer.

Payment processing system 100 has a plurality of prepaid accounts 108 each of which is held by a corresponding account holder (l) 108 through account holder (A) 108, where A can be up to and greater than a ten digit integer.

Payment processing system 100 includes account user (1) 108 through account user (AU) 108, where AU can be as large as a ten digit integer or larger. Each account user (au) 108 conducts a transaction for goods and/or services with merchant (m) 110 using an account (i.e., a prepaid account) that has been issued by an issuer (i) 104 to a corresponding account holder (a) 108. Data from the transaction on the account is collected by merchant (m) 110 and forwarded to a corresponding acquirer (q) 106. Acquirer (q) 106 forwards the data to transaction handler 102 who facilitates payment for the transaction from the prepaid account issued by the issuer (i) 104 to account holder (a) 108.

Payment processing system 100 has a plurality of issuers 104. Each issuer (i) 104 may be assisted in processing one or more transactions by a corresponding agent issuer (ai) 104, where ‘i’ can be an integer from 1 to I, where ‘ai’ can be an integer from 1 to AI, and where I and AI can be as large as an eight digit integer or larger.

Payment processing system 100 has a plurality of acquirers 106. Each acquirer (q) 106 may be assisted in processing one or more transactions by a corresponding agent acquirer (aq) 106, where ‘q’ can be an integer from 1 to Q, where aq can be an integer from 1 to AQ, and where Q and AQ can be as large as an eight digit integer or larger.

Payment processing system 100 has a transaction handler 102 to process a plurality of transactions. The transaction handler 102 can include one or a plurality of networks and switches 102. Each network/switch (ns) 102 can be a mainframe computer in a geographic location different than each other network/switch (ns) 102, where ‘ns’ is an integer from one to NS, and where NS can be as large as a four digit integer or larger.

Dedicated communication systems 120, 122 (i.e., private communication network(s)) facilitate communication between the transaction handler 102 and each issuer (i) 104 and each acquirer (q) 106. The Internet 112, via e-mail, the World Wide Web, cellular telephony, and/or other optional public and private communications systems, can facilitate communications 122a-122e among and between each issuer (i) 104, each acquirer (q) 106, each merchant (m) 110, each account holder (a) 108, and the transaction handler 102. Alternatively and optionally, one or more dedicated communication systems 124, 126, and 128 can facilitate respective communications between each acquirer (q) 106 and each merchant (m) 110, each merchant (m) 110 and each account holder (a) 108, and each account holder (a) 108 and each issuer (i) 104, respectively.

Each acquirer (q) 106 may be assisted in processing one or more transactions by a corresponding agent acquirer (aq) 106, where ‘q’ can be an integer from 1 to Q, where aq can be an integer from 1 to AQ, and where Q and AQ can be as large as an eight digit integer or larger.

Merchant (m) 110 may be a person or entity that sells goods and/or services. Merchant (m) 110 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder (a) 108 may be a second merchant making a purchase from another merchant (m) 110. Merchant (m) 110 may utilize at least one point-of-sale terminal (POS) that can communicate with acquirer (q) 106, transaction handler 102, or issuer (i) 104. Thus, the POS terminal is in operative communication with the payment processing system 100.

Typically, a transaction begins with account user (au) 108 presenting a portable consumer device to merchant (m) 110 to initiate an exchange for a good or service. The portable consumer device may be associated with an account (e.g., a prepaid account) of account holder (a) 108 that was issued to the account holder (a) 108 by issuer (i) 104.

The portable consumer device may be in a form factor that can be a payment card, a gift card, a smartcard, a smart media, a payroll card, a healthcare card, a wrist band, a machine readable medium containing account information, a keychain device, such as a SPEEDPASS® device commercially available from ExxonMobil Corporation, or a supermarket discount card, a cellular phone, personal digital assistant, a pager, a security card, an access card, a wireless terminal, or a transponder. The portable consumer device may include a volatile or non-volatile memory to store information such as the account number or an account holder (a) 108's name.

Merchant (m) 110 may use the POS terminal to obtain account information, such as a number of the account of the account holder (a) 108, from the portable consumer device. The portable consumer device may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request message to the issuer (i) 104 of the account corresponding to the portable consumer device. Alternatively, or in combination, the portable consumer device may communicate with issuer (i) 104, transaction handler 102, or acquirer (q) 106.

Issuer (i) 104 may authorize the transaction using transaction handler 102. Transaction handler 102 may also clear the transaction. Authorization includes issuer (i) 104, or transaction handler 102 on behalf of issuer (i) 104, authorizing the transaction in connection with issuer (i) 104's instructions such as through the use of business rules. The business rules could include instructions or guidelines from transaction handler 102, account holder (a) 108, merchant (m) 110, acquirer (q) 106, issuer (i) 104, a related financial institution, or combinations thereof. Transaction handler 102 may maintain a log or history of authorized transactions. Once approved, merchant (m) 110 will record the authorization, allowing account user (au) 108 to receive the good or service from merchant (m) 110 or an agent thereof.

Merchant (m) 110 may, at discrete periods, such as the end of the day, submit a list of authorized transactions to acquirer (q) 106 or other transaction related data for processing through the payment processing system 100. Transaction handler 102 may compare the submitted authorized transaction list with its own log of authorized transactions. If a match is found, transaction handler 102 may route authorization transaction amount requests from the corresponding acquirer (q) 106 to the corresponding issuer (i) 104 involved in each transaction. Once acquirer (q) 106 receives the payment of the authorized transaction amount from issuer (i) 104, acquirer (q) 106 can forward the payment to merchant (m) 110 less any transaction costs, such as fees for the processing of the transaction. If the transaction involves a debit or pre-paid card, acquirer (q) 106 may choose not to wait for the issuer (i) 104 to forward the payment prior to paying merchant (m) 110.

There may be intermittent steps in the foregoing process, some of which may occur simultaneously. For example, acquirer (q) 106 can initiate the clearing and settling process, which can result in payment to acquirer (q) 106 for the amount of the transaction. Acquirer (q) 106 may request from transaction handler 102 that the transaction be cleared and settled. Clearing includes the exchange of financial information between the issuer (i) 104 and the acquirer (q) 106 and settlement includes the exchange of funds. Transaction handler 102 can provide services in connection with settlement of the transaction. The settlement of a transaction includes depositing an amount of the transaction settlement from a settlement house, such as a settlement bank, which transaction handler 102 typically chooses, into a clearinghouse, such as a clearing bank, that acquirer (q) 106 typically chooses. Issuer (i) 104 deposits the same from a clearinghouse, such as a clearing bank, which issuer (i) 104 typically chooses, into the settlement house. Thus, a typical transaction involves various entities to request, authorize, and fulfill processing the transaction.

Payment processing system 100 will preferably have network components suitable for scaling the number and data payload size of transactions that can be authorized, cleared and settled in both real time and batch processing. These include hardware, software, data elements, and storage network devices for the same. Examples of payment processing system 100 include those operated, at least in part, by American Express, Master Card, Discover Card, First Data Corporation, Diners Club, and Visa Inc., and agents of the foregoing.

Each network/switch (ns) 102 can include one or more data centers for processing transactions, where each transaction can include up to 100 kilobytes of data or more. The data corresponding to the transaction can include information about the types and quantities of goods and services in the transaction, information about the account holder (a) 108, the account user (au) 108, the merchant (m) 110, tax and incentive treatment(s) of the goods and services, coupons, rebates, rewards, loyalty, discounts, returns, exchanges, cash-back transactions, etc.

By way of example, network/switch (ns) 102 can include one or more mainframe computers (i.e., one or more IBM mainframe computers) for communications over systems 120, 122, one or more server farms (i.e., one or more Sun UNIX Superservers), where the mainframe computers and server farms can be in diverse geographic locations.

Each issuer (i) 104 (or agent issuer (ai) 104 thereof) and each acquirer (q) 106 (or agent acquirer (aq) 106 thereof) can use one or more router/switch (i.e., Cisco routers/switches) to communicate with each network/switch (ns) 102 via dedicated communication systems 120, 122, respectively.

Transaction handler 102 stores information about transactions processed through payment processing system 100 in data warehouses such as may be incorporated as part of the plurality of networks/switches 102. This information can be data mined. The data mining transaction research and modeling can be used for advertising, account holder and merchant loyalty incentives and rewards, fraud detection and prediction, and to develop tools to demonstrate savings and efficiencies made possible by use of the payment processing system 100 over paying and being paid by cash, checks, or other traditional payment mechanisms.

FIG. 1 includes one or more transaction handlers transaction handler (th) 102 and access points 130, 132. Other entities such as drawee banks and third party authorizing agents may also connect to the network through an access point. An interchange center is a data processing center that may be located anywhere in the world. In one embodiment, there are two in the United States and one each in the United Kingdom and in Japan. Each interchange center houses the computer system that performs the network transaction processing. The interchange center serves as the control point for the telecommunication facilities of the network, which comprise high speed leased lines or satellite connections based on IBM SNA protocol. Preferable, the communication lines that connect an interchange center (transaction handlers 202, 1406) to remote entities use dedicated high-bandwidth telephone circuits or satellite connections based on the IBM SNA-LUO communication protocol. Messages are sent over these lines using any suitable implementation of the ISO 8583 standard.

Access points 130, 132 are typically made up of small computer systems located at a processing center that interfaces between the center's host computer and the interchange center The access point facilitates the transmission of messages and files between the host and the interchange center supporting the authorization, clearing and settlement of transaction. Telecommunication links between the acquirer (q) 106 and its access point, and between the access point and issuer (i) 104 are typically local links within a center and use a proprietary message format as preferred by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. Also, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

Transaction handler (th) 102 can store information about transactions processed through transaction processing system 100 in data warehouses such as may be incorporated as part of the plurality of networks/switches 102. This information can be data mined. The data mining transaction research and modeling can be used for advertising, account holder and merchant loyalty incentives and rewards, fraud detection and prediction, and to develop tools to demonstrate savings and efficiencies made possible by use of the transaction processing system 100 over paying and being paid by cash, or other traditional payment mechanisms.

The VisaNet® system is an example component of the transaction handler (th) 102 in the transaction processing system 100. Presently, the VisaNet® system is operated in part by Visa Inc. As of 2006, the VisaNet® system Inc. was processing around 300 million transaction daily, on over 1 billion accounts used in over 170 countries. Financial instructions numbering over 16,000 connected through the VisaNet® system to around 30 million merchants (m) 110. In 2007, around 71 billion transactions for about 4 trillion U.S. dollars were cleared and settled through the VisaNet® system, some of which involved a communication length of around 24,000 miles in around two (2) seconds and during which a plurality of stops are made for processing data in the transaction.

The steps, methods, processes, and devices described in connection with the implementations disclosed herein, are made with reference to the Figures, in which like numerals represent the same or similar elements. While described in terms of the best mode, it will be appreciated by those skilled in the relevant arts that the description is intended to cover alternatives, modifications, and equivalents as may be included within the spirit and scope of the invention as defined by the appended claims and their equivalents as supported by the following disclosure and drawings. Reference throughout this specification to “one implementation,” “an implementation,” or similar language means that a particular feature, structure, or characteristic described in connection with the implementation is included in at least one implementation of the present invention. Thus, appearances of the phrases “in one implementation,” “in an implementation,” and similar language throughout this specification may, but do not necessarily, all refer to the same implementation.

The described features, structures, or characteristics of the invention may be combined in any suitable manner in one or more implementations. In the following description, numerous specific details are recited to provide a thorough understanding of implementations of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The steps of a method, process, or algorithm described in connection with the implementations disclosed herein may be embodied directly in hardware, in a software module executed by a processor, or in a combination of the two. In certain implementations, instructions are encoded in a non-transient computer readable medium wherein those instructions are executed by a hardware to perform one or more steps of the method, process, or algorithm.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising a plurality of steps, each being performed by computing hardware executing software, wherein the steps include:
receiving one or more authorization messages for a transaction on an account between a merchant and a consumer, wherein the one or more authorization messages include:
an account identifier corresponding to the account issued by an issuer to the consumer;
one or more Globally Unique Item Identifiers (GUIIDs) each corresponding to an item purchased in the transaction; and
information pertaining to the transaction including confirmation that the transaction on the account had been authorized by the issuer of the account;
identifying, using the account identifier, a consumer file from a plurality of said consumer files stored in a consumer database;
and
for each said GUIID:
identifying, using the GUIID, the item and a corresponding Globally Unique Warranty Identifier (GUWID) in a warranty database, wherein the warranty database includes a plurality of said GUWIDs each having a corresponding express warranty for a corresponding said item;
storing in association with the identified said consumer file in the consumer database:
the GUWID for the corresponding said item; and
at least a portion of the information pertaining to the transaction.

2. The method, as defined in claim 1, wherein the steps further comprise:
receiving a consumer warranty request that includes the account identifier;
retrieving, using the account identifier, the consumer file from the consumer database;
retrieving each said GUWID that was stored in the consumer file that was retrieved from the consumer database;
retrieving, from the warranty database, each said express warranty corresponding to each said GUWID stored within from the retrieved said consumer file from the consumer database; and
transmitting, in response to the consumer warranty request, the express warranties that were retrieved from the warranty database.

3. The method, as defined in claim 2, wherein:
each said express warranty associated with each said GUWID that is stored in the warranty database includes express warranty terms that specify the validity of the express warranty;
the at least a portion of the information pertaining to the transaction that is respectively stored with the corresponding said GUWID includes at least one of:
a time of the transaction;
a location of the transaction;
a jurisdiction of the transaction; and
an identifier for the merchant;
the step of the retrieving, from the warranty database, further comprises:
comparing the express warranty terms for each said express warranty that was retrieved from the warranty database to at least one of:
the time of the transaction;
the location of the transaction;
the jurisdiction of the transaction; and
the identifier for the merchant;
and
deriving, from the comparison, respective subsets of the express warranties that were retrieved from the warranty database for which the express warranty terms thereof are valid and are valid;
and
the step of the transmitting further comprises transmitting information, in response to the consumer warranty request, as to the respective subsets of the express warranties that are valid and are not valid.

4. The method, as defined in claim 1, wherein:
the authorization message is a financial transaction card originated message having one or more private use fields and for which interchange message specifications are predetermined for the exchange of electronic said transactions made by cardholders using payment cards; and
one or more said GUWIDs are stored in the one or more private use fields of the authorization message.

5. The method as defined in claim 4, wherein:
each said authorization message is selected from the group consisting of an authorization request message, an authorization response message, and a combination of the foregoing; and
the account corresponding to the account identifier in the authorization message is selected from the group consisting of:
a debit account issued by the issuer to the consumer or a party to whom the consumer is an agent;
a credit account issued by the issuer to the consumer or a party to whom the consumer is an agent; and
a prepaid account issued by the issuer to the consumer or a party to whom the consumer is an agent;
an Automated Clearing House (ACH) account issued by the issuer to the consumer or a party to whom the consumer is an agent; and
a checking account issued by the issuer to the consumer or a party to whom the consumer is an agent.

6. An apparatus comprising one or more servers in communication over a network for performing the method of claim 1.

7. A non-transient computer readable medium comprising instructions executable by hardware to perform the method of claim 1.

8. A method of storing a warranty for an item purchased on an account, the method comprising a plurality of steps, each being performed by computing hardware executing software, wherein the steps include:
receiving a warranty storage request containing an express warranty for an item and a corresponding Globally Unique Warranty Identifier (GUWID) for the item;
storing the express warranty, in association with the corresponding GUWID, in a warranty database comprising a plurality of said express warranties and respective said GUWIDs;
receiving an authorization message that includes:
an account identifier corresponding to the account; and the GUWID; and
information confirming that the transaction on the account has been authorized by the issuer of the account, wherein:
the authorization message is for a transaction on the account between a consumer and a merchant; and
the account was issued by an issuer to the consumer;
identifying, using the GUWID, the express warranty from the plurality of said express warranties in the warranty database;
identifying, using the account identifier, a consumer file from a plurality of said consumer files stored in a consumer database;
storing the GUWID in association with the identified said consumer file in the consumer database;
receiving a consumer warranty request that includes the account identifier;
retrieving, using the account identifier, the consumer file from the consumer database;
retrieving each said GUWID that was stored in the consumer file that was retrieved from the consumer database;
retrieving, from the warranty database, each said express warranty corresponding to each said GUWID stored within from the retrieved said consumer file from the consumer database; and
transmitting, in response to the consumer warranty request, the express warranties that were retrieved from the warranty database.

9. The method, as defined in claim 8, wherein:
each said express warranty associated with each said GUWID that is stored in the warranty database includes express warranty terms that specify the validity of the express warranty;
the authorization message further includes at least one of:
a time of the transaction;
a location of the transaction;
a jurisdiction of the transaction; and
an identifier for the merchant;
the steps further include storing with the GUWID, in association with the identified said consumer file in the consumer database, at least one of:
the time of the transaction;
the location of the transaction;
the jurisdiction of the transaction; and
the identifier for the merchant;
the step of the retrieving, from the warranty database, further comprises:
comparing the express warranty terms for each said express warranty that was retrieved from the warranty database to at least one of:
the time of the transaction;
the location of the transaction;
the jurisdiction of the transaction; and
the identifier for the merchant;
and
deriving, from the comparison, respective subsets of the express warranties that were retrieved from the warranty database for which the express warranty terms thereof are valid and are valid;
and
the step of the transmitting further comprises transmitting information, in response to the consumer warranty request, as to the respective subsets of the express warranties that are valid and are not valid.

10. The method, as defined in claim 8, wherein:
the authorization message includes a plurality of said GUWIDs;
and
the for each said GUWID in the authorization message:
identifying, using the GUWID, a corresponding said express warranty from the plurality of said express warranties in the warranty database;
identifying, using the account identifier, one said a consumer file from the plurality of said consumer files stored in the consumer database; and
storing the GUWID in association with the identified said consumer filed in the consumer database.

11. The method, as defined in claim 8, wherein:
the authorization message is a financial transaction card originated message having one or more private use fields and for which interchange message specifications are predetermined for the exchange of electronic said transactions made by cardholders using payment cards; and
one or more said GUWIDs are stored in the one or more private use fields of the authorization message.

12. The method as defined in claim 11, wherein the account corresponding to the account identifier in the authorization message is selected from the group consisting of:
a debit account issued by an issuer to the consumer or a party to whom the consumer is an agent;
a credit account issued by an issuer to the consumer or a party to whom the consumer is an agent; and
a prepaid account issued by an issuer to the consumer or a party to whom the consumer is an agent;
an Automated Clearing House (ACH) account issued by an issuer to the consumer or a party to whom the consumer is an agent; and
a checking account issued by an issuer to the consumer or a party to whom the consumer is an agent.

13. An apparatus comprising one or more servers in communication over a network for performing the method of claim 8.

14. A non-transient computer readable medium comprising instructions executable by hardware to perform the method of claim 8.

15. A method comprising a plurality of steps, each being performed by computing hardware executing software, wherein the steps include:
receiving one or more item purchase storage requests, wherein each said item purchase storage request includes:
a Globally Unique Consumer Identifier (GUCID);
a Globally Unique Item Identifier (GUIID) corresponding to an item purchased in a transaction; and
information pertaining to the transaction;
for each said item purchase storage request that was received:
identifying, using the GUCID, a consumer file from a plurality of said consumer files stored in a consumer database;
identifying, using the GUIID, the item and a corresponding Globally Unique Warranty Identifier (GUWID) in a warranty database, wherein the warranty database includes a plurality of said GUWIDs each having a corresponding express warranty for a corresponding said item;
storing in association with the identified said consumer file in the consumer database:
the GUWID; and
the information pertaining to the transaction;
receiving a consumer warranty request that includes the GUCID;
retrieving, using the GUCID, the consumer file from the consumer database;
retrieving each said GUWID that was stored in the consumer file that was retrieved from the consumer database;
retrieving, from the warranty database, each said express warranty corresponding to each said GUWID stored within from the retrieved said consumer file from the consumer database; and
transmitting, in response to the consumer warranty request, the express warranties that were retrieved from the warranty database.

16. The method, as defined in claim 15, wherein:
each said express warranty associated with each said GUWID that is stored in the warranty database includes express warranty terms that specify the validity of the express warranty;
for each said item purchase storage request, the information pertaining to the transaction includes at least one of:
a time of the transaction;
a location of the transaction;
a jurisdiction of the transaction; and
an identifier for the merchant;
the steps further include storing with the GUWID, in association with the identified said consumer file in the consumer database, at least one of:
the time of the transaction;
the location of the transaction;
the jurisdiction of the transaction; and
the identifier for the merchant;
the step of the retrieving, from the warranty database, further comprises:
comparing the express warranty terms for each said express warranty that was retrieved from the warranty database to at least one of:
the time of the transaction;
the location of the transaction;
the jurisdiction of the transaction; and
the identifier for the merchant;
and
deriving, from the comparison, respective subsets of the express warranties that were retrieved from the warranty database for which the express warranty terms thereof are valid and are not valid;
and
the step of the transmitting further comprises transmitting information, in response to the consumer warranty request, as to the respective subsets of the express warranties that are valid and are not valid.

17. The method as defined in claim 15, wherein:
each said GUCID is an identifier for an account issued by an issuer to a consumer;
each said transaction was conducted on the account between a merchant and the consumer for the purchase of one or more said items each having a corresponding said GUIID.

18. The method as defined in claim 17, wherein each said account issued by each said issuer to each said consumer is selected from the group consisting of:
a debit account issued by the issuer to the consumer or a party to whom the consumer is an agent;
a credit account issued by the issuer to the consumer or a party to whom the consumer is an agent; and
a prepaid account issued by the issuer to the consumer or a party to whom the consumer is an agent;
an Automated Clearing House (ACH) account issued by the issuer to the consumer or a party to whom the consumer is an agent; and
a checking account issued by the issuer to the consumer or a party to whom the consumer is an agent.

19. The method, as defined in claim 15, wherein, for each said express warranty corresponding to each said GUWID stored within from the retrieved said consumer file from the consumer database, the steps further comprise:
retrieving from a legal database, using the information pertaining to the transaction, one or more implied warranties pertaining to the transaction; and
transmitting, in response to the consumer warranty request, the one or more implied warranties pertaining to the transaction.

20. An apparatus comprising one or more servers in communication over a network or performing the method of claim 15.

21. A non-transient computer readable medium comprising instructions executable by hardware to perform the method of claim 15.
